(19) United States
(12) Patent Application Publication
(10) Pub. No.: US 2014/0136364 A1
(43) Pub. Date: May 15, 2014

(54) CONFIGURING AND DISPLAYING INTERACTION INFORMATION WITHIN USER INTERFACES

(71) Applicant: EBAY INC., San Jose, CA (US)

(72) Inventor: Akshay Gadre, North Wales, PA (US)

(73) Assignee: eBay Inc., San Jose, CA (US)

(21) Appl. No.: 13/673,402

(22) Filed: Nov. 9, 2012

(51) Int. Cl. G06Q 30/06

(52) U.S. Cl. CPC G06Q 30/0641; G06Q 30/0633
USPC 705/26.8; 705/27.1

(57) ABSTRACT

A system and method for configuring, selecting and/or displaying interaction information associated with a product via a web or mobile page is described. In some examples, the system configures and/or selects interaction information based on a type of page, type of information displayed by the page, and/or location within a website that is displaying the interaction information, and displays the interaction information as a graphical influence element or other displayable content via the page.

### TECHNICAL FIELD

This application relates generally to information retrieval, and specifically, to a system and method for displaying interaction information via user interfaces.

### BACKGROUND

General merchandising of items for sale via a network-based merchandising system is well known. Many websites accessible via the Internet are operated as online stores or auctions. These websites enable users to purchase items that may be physical items (e.g., an article of clothing), electronic data items (e.g., a downloadable digital media product), or services to be rendered by an affiliated service provider. To facilitate potential transactions and thereby improve user experiences, some websites provide recommendations and other information associated with displayed items to users of the websites.

### BRIEF DESCRIPTION OF THE DRAWINGS

The present technology is illustrated by way of example, and not by way of limitation, in the figures of the accompanying drawings.

FIG. 1 is a display diagram illustrating a website displaying interaction information, in some example embodiments.

FIG. 2 is a block diagram illustrating a network architecture of a system used to display interaction information within websites, in some example embodiments.

FIG. 3 is a block diagram illustrating a publication system of available products, in some example embodiments.

FIG. 4 is a flow diagram illustrating a method for displaying interaction information within pages of a website, in some example embodiments.

FIG. 5 is a flow diagram illustrating a method for selecting the interaction information to display based on a viewer of a website, in some example embodiments.

FIGS. 6A-6C are display diagrams illustrating displayed interaction information within various pages presented by a website, in some example embodiments.

FIG. 7 shows a diagrammatic representation of a machine in the example form of a computer system within which a set of instructions may be executed to cause the machine to perform any one or more of the methodologies discussed herein.

### DETAILED DESCRIPTION

### Overview

Methods and systems to configure, select and/or display interaction, or influence, information associated with a product or service via a web or mobile page are described. In some examples, the methods and systems select interaction information based on a type of page, type of information displayed by the page, location within a website that is displaying the interaction information, or other rules-based process, and display the interaction information as a graphical influence element or other displayable content via the page.

The interaction information may be information associated with a product that is derived and/or generated from other user interactions with the product, such as information identifying a number of viewers of a web page displaying a description of the product, a number of members of a social network that are connected (e.g., members that “like” or otherwise provide comments about the product) to a product page featuring the product, and so on. That is, the interaction information may reflect a degree of interaction relating to the product.

A user interface, such as an interface presented within a web or mobile page may display, present, and/or publish the interaction information along with product information via a graphical user influence element, which may be a published display element that includes words, pictures, audio clips, video clips, and/or other media used to present the interaction information.

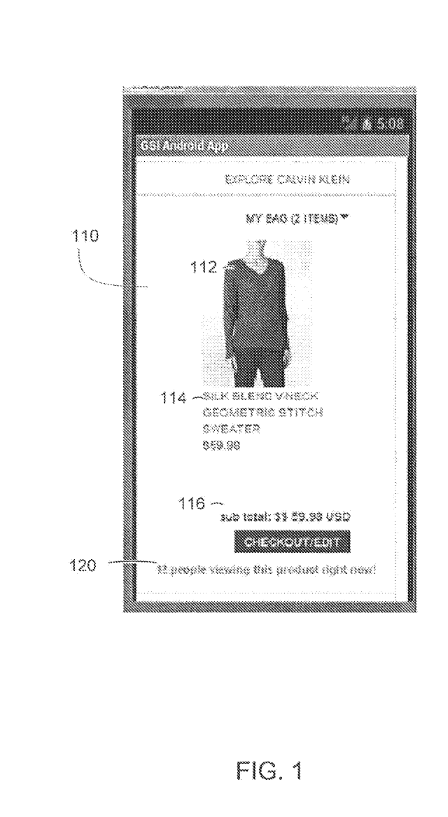

As an example, FIG. 1 depicts a display diagram illustrating a mobile web page 100 that displays interaction information along with a product for purchase via a product description page 100, in some example embodiments. The web page 100 includes product description information 110, such as a photo 112 of the product, a description 114 of the product, and other information 116. Interaction information, in the form of graphical influence element 120 displaying a message of “12 people viewing this product right now!”, is presented along with the product information 110 via the web page 100. Of course, one of ordinary skill in the art will appreciate that the web page 100 may display various different types of interaction information based on determinations of a rules-based process for configuring and/or selecting the interaction information to be displayed.

Thus, in some examples, the display of interaction information along with a product for purchase via a web page 100 enables a publisher of the web page 100 to provide targeted and influential information during various stages of product purchase and checkout process, among other benefits. That is, the method and systems described herein enable e-commerce retailers to configure displayed information using a rules based engine. Based on the configuration, retailers may display to end users different types of interaction information during their shopping experiences, among other benefits.

### Suitable System

In the following description, for purposes of explanation, numerous specific details are set forth in order to provide a thorough understanding of the present disclosure. It may be evident, however, to one skilled in the art that the subject matter of the present disclosure may be practiced without these specific details.

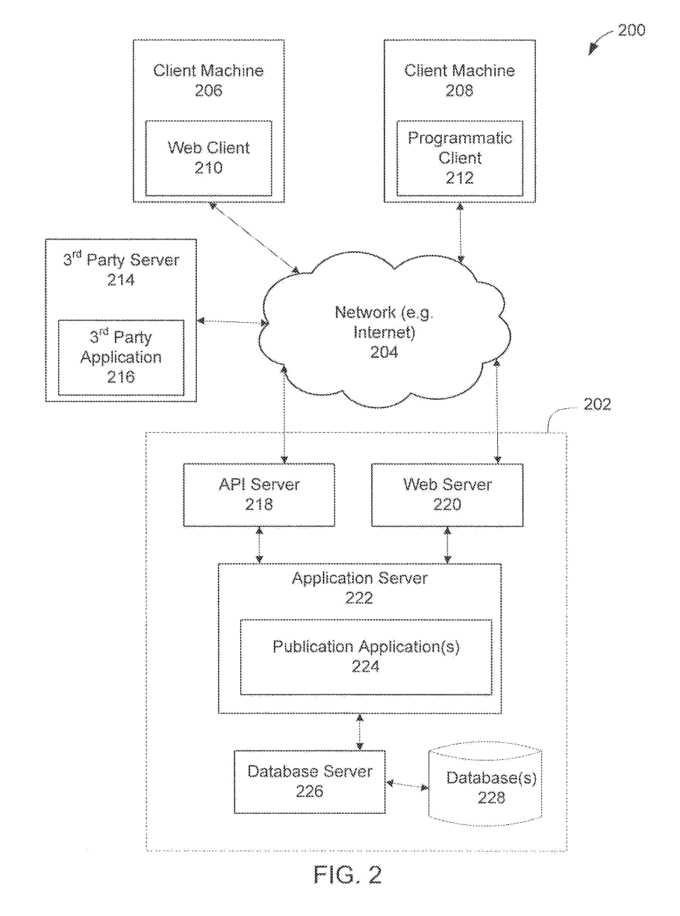

FIG. 2 is a block diagram illustrating a network architecture of a system used to display interaction information via web pages, in some example embodiments. For example, the network system 200 may be a publication/publisher system 202 where clients may communicate and exchange data within the network system 200. The data may pertain to various functions (e.g., selling and purchasing of items) and aspects (e.g., data describing items listed on the publication/publisher system) associated with the network system 200 and its users. Although illustrated herein as a client-server architecture as an example, other example embodiments may include other network architectures, such as a peer-to-peer or distributed network environment.

A data exchange platform, in an example firm of a network-based publisher 202, may provide server-side functionality, via a network 204 (e.g., the Internet) to one or more clients. The one or more clients may include users that utilize the network system 200 and more specifically, the network-based publisher 202, to exchange data over the network 204. These transactions may include transmitting, receiving (communicating) and processing data to, from, and regarding content and users of the network system 200. The data may include, but are not limited to, content and user data such as feedback data; user reputation values; user profiles; user attributes; product and service reviews; product, service, manufacture, and vendor recommendations and identifiers; product and service listings associated with buyers and sellers; auction bids; influence data; and transaction data, among other things.

In various embodiments, the data exchanges within the network system 200 may be dependent upon user-selected functions available through one or more client or user interfaces (UIs). The UIs may be associated with a client machine, such as a client machine 206 using a web client 210. The web client 210 may be in communication with the network-based publisher 202 via a web server 220. The his may also be associated with a client machine 208 using a programmatic client 212, such as a client application, or a third party server 214 hosting a third party application 216. It can be appreciated in various embodiments the client machine 206, 208, or third party server 214 may be associated with a buyer, a seller, a third party electronic commerce platform, a payment service provider, or a shipping service provider, each in communication with the network-based publisher 202 and optionally each other. The buyers and sellers may be any one of individuals, merchants, or service providers, among other things.

Turning to the network-based publisher 202, an application program interface (API) server 218 and a web server 220 are coupled to, and provide programmatic and web interfaces respectively to, one or more application servers 222. The application servers 222 host one or more publication application(s) 224. The application servers 222 are, in turn, shown to be coupled to one or more database server(s) 226 that facilitate access to one or more database(s) 228.

In some example embodiments, the web server 220 and the API server 218 communicate and receive data pertaining to listings, transactions, and feedback, among other things, via various user input tools. For example, the web server 220 may send and receive data to and from a toolbar or webpage on a browser application (e.g., web client 210) operating on a client machine (e.g., client machine 206). The API server 218 may send and receive data to and from an application (e.g., client application 212 or third party application 216) running on another client machine (e.g., client machine 208 or third party server 214).

The publication application(s) 224 may provide a number of publisher functions and services (e.g., search, listing, payment, etc.) to users that access the network-based publisher 202. For example, the publication application(s) 224 may provide a number of services and functions to users for listing goods and/or services for sale, searching for goods and services, facilitating transactions, and reviewing and providing feedback about transactions and associated users. Additionally, the publication application(s) 224 may track and store data and metadata relating to listings, transactions, and user interactions with the network-based publisher 202.

FIG. 2 also illustrates a third party application 216 that may execute on a third party server 214 and may have programmatic access to the network-based publisher 202 via the programmatic interface provided by the API server 218. For example, the third party application 216 may use information retrieved from the network-based publisher 202 to support one or more features or functions on a website hosted by the third party. The third party website may, for example, provide one or more listing, feedback, publisher or payment functions that are supported by the relevant applications of the network-based publisher 202.

While the example network architecture 200 of FIG. 2 employs a client-server architecture, a skilled artisan will recognize that the present disclosure is not limited to such an architecture. The example network architecture 200 can equally well find application in, for example, a distributed or peer-to-peer architecture system.

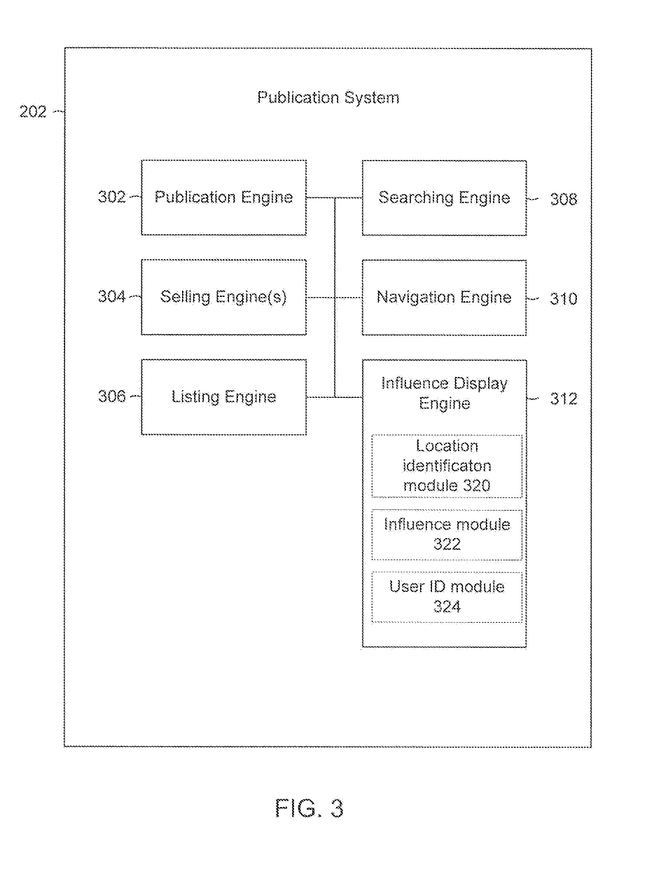

Referring now to FIG. 3, an example block diagram illustrating multiple components that, in some example embodiments, are provided within the publication system 202 of the networked system 200 is shown. The publication system 202 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources to allow information to be passed between the components or to allow the components to share and access common data. Furthermore, the components may access the one or more database(s) 228 via the one or more database servers 226, both shown in FIG. 2.

In some example embodiments, the publication system 202 comprises a network-based marketplace and provides a number of publishing, listing, and price-setting mechanisms whereby a seller (e.g., business or consumer) may list (or publish information concerning) goods or services for sale, a buyer can search for, express interest in, or indicate a desire to purchase such goods or services, and a price can be set for a transaction pertaining to the goods or services. To this end, the publication system 202 may comprise at least one publication engine 302 and one or more selling engines 304. The publication engine 302 may publish information, such as item listings or product description pages, on the publication system 202. In some example embodiments, the selling engines 304 may comprise one or more auction engines that support auction-format listing and price setting mechanisms (e.g., English, Dutch, Chinese, Double, Reverse auctions, and so on). The various auction engines may also provide a number of features in support of these auction-format listings, such as a reserve price feature whereby a seller may specify a reserve price in connection with a listing and a proxy-bidding feature whereby a bidder may invoke automated proxy bidding.

A listing engine 306 allows sellers to conveniently author listings of items or authors to author publications. In some example embodiments, the listings pertain to goods or services that a user (e.g., a seller) wishes to transact via the publication system 202. Each good or service is associated with a particular category. The listing engine 306 may receive listing data such as title, description, and aspect name/value pairs. Furthermore, each listing for a good or service may be assigned an item identifier. In some example embodiments, a user may create a listing that is an advertisement or other form of information publication. The listing information may then be stored to one or more storage devices coupled to the publication system 202 (e.g., databases 228). Listings may also comprise product description pages that display a product and information (e.g., product title, specifications, reviews, and so on) associated with the product. In some example embodiments, the product description page may include an aggregation of item listings that correspond to the product described on the product description page.

A searching engine 308 facilitates searching the network-based publication system 202. For example, the searching engine 308 enables keyword queries of listings published via, the publication system 202. In some example embodiments, the searching engine 308 receives the keyword queries from a computing device associated with a user and conducts a review of the storage device storing the listing information. The review will enable compilation of a result set of listings that may be sorted and returned to the client device (e.g., client machine 206) of the user. The searching engine 308 may record the query (e.g., keywords) and any subsequent user actions and behaviors (e.g., navigations).

A navigation engine 310 enables users to navigate through various categories, catalogs, or inventory data structures according to which listings may be classified within the publication system 202. For example, the navigation engine 310 allows a user to successively navigate down a category tree comprising a hierarchy of categories until a particular set of listing is reached. Various other navigation applications within the navigation engine 310 may be provided to supplement the searching and browsing applications. The navigation engine 310 may record the various user actions (e.g., clicks) performed by the user in order to navigate down the category tree.

In some examples, an influence display engine 312 may generate and/or select interaction information to be published by the publishing engine 302 via various pages of a website. For example, the influence display engine 312 may generate and/or select information associated with products displayed via a website, such as information representing users, customers, friends, social networks, and so on, that interact with. the displayed products. The influence display engine 312 may display such interaction information via one or more pages of a flow of pages that facilitate a purchase of the products via the website. Example pages may include product description pages, purchase pages, order review pages, product review pages, and so on.

The displayed interaction information may be selected, generated, and/or derived from a variety of sources, such as social network websites, micro-blogs, news and other online content sites, and so on. For example, interaction information may include:
information representing and/or indicating an aggregated grouping of user interactions with a product, e.g., “32 of your friends like this dress!” or “there are 3,456 people viewing this car right now!”;
information representing and/or indicating the use, sale, views, and/or other interactions between users and a product, e.g., “25 people have purchased this book in the past hour” or “9 of your friends have ordered this sandwich in the past month”;
information representing and/or indicating content presented for a product at a third-party site, such as a micro-blog, social network site, and so on, e.g., “@janedoe just tweeted about this movie—‘whoa, that movie just made me weep’”; and so on.

Thus, in some examples, interaction information includes dynamically created or updated information associated with a product or other entity displayed within a websites, such as information derived or generated from user interactions associated with the product via a website presenting the product and/or via other websites or third-party entities associated with the product.

In some examples, the influence display engine 312 may include one or more modules and/or components to perform one or more operations of the influence display engine 312, The modules may be hardware, software, or a combination of hardware and software. The modules may be executed by one or more processors. For example, the influence display engine 312 may include a location identification module 320, an influence module 322, and a user identification module 324.

In some examples, the location identification module 320 is configured and/or programmed to identify a location within a website in which to display interaction information for a product presented by the website. For example, the identified location within the website may be a certain page displayed by a website, a certain location of a page displayed by a website, a certain location at or proximate to content within a page displayed by a website, a certain page currently viewed by a viewer of a website, and so on.

In some examples, the influence module 322 is configured and/or programmed to generate and/or select interaction information to display at the identified location within the website based on a rules-based process, such as a rules-based process that includes the identified location. For example, the influence module 322 may select and/or generate interaction information based on a type of page currently viewed by a user, based on a type of user viewing the website, and so on. For example, the influence module 322 may follow one or more of the following rules when selecting and/or generating interaction information to be displayed within a website:

when the viewed page is a product description page, generate interaction information identifying a number of items sold within a given time period;
when the viewed page is a purchase page, generate interaction information identifying a number of current viewers of the product description page;
when the viewed page is a shopping cart page, generate interaction information identifying a number of social network friends of a viewer that have “liked” the product;
when the viewed page is a product review page, select content from a micro-blog that is associated with the product; and so on.

Of course, other rules may be followed by the influence module 322 when generating and/or selecting interaction information.

In some examples, the user identification module 324 is configured and/or programmed to identify a user, such as a viewer, of a website. The user identification module 324 may identify and/or determine a user type for the user, biographical information for the user, an interaction history for the user, current online session information for the user, and so on.

The influence module 322, in some examples, may utilize such information when selecting and/or generating interaction information, among other things. For example, the user identification module 324 may determine a current viewer of a website is a female between the ages of 35-39 that has purchased many products from the website in the past, and the influence module 322 may utilize such information when selecting the interaction information to display within various pages of the website.

Thus, in some examples, the influence engine 312 is configured to receive an indication that a viewer of a website has navigated to a page associated with a product available for purchase via the website, select and/or generate an influence element associated with the page, and display the influence element via the page.

Although the various components of the publication system 202 have been discussed in terms of a variety of individual modules and engines, one skilled in the art will recognize that many of the components can be combined or organized in other ways. Furthermore, not all components of the publication system 202 have been included in FIG. 3. In general, components, protocols, structures, and techniques not directly related to functions of example embodiments (e.g., dispute resolution engine, loyalty promotion engine, reputation engines, listing management engines, account engine) have not been shown or discussed in detail. The description given herein simply provides a variety of example embodiments o aid the reader in an understanding of the systems and methods used herein.

### Displaying Interaction Information Along with Products Via a Web Page

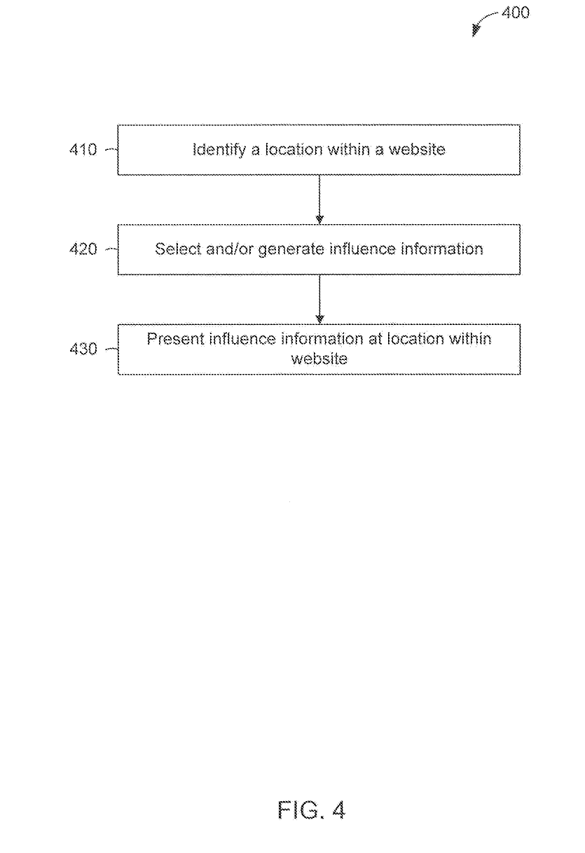

As described herein, the influence display engine 312 may identify and select interaction information to display along with product information 110 presented via a page of a website. FIG. 4 is a flow diagram illustrating a method 400 for displaying interaction information within pages of a website, in some example embodiments.

In operation 410, the system identifies a location within a website. For example, the location identification module 320 of the influence display engine 312 may identify a certain page, a certain location within a page, certain information associated with a product, and so on, within a website.

The system may identify the location in a number of ways. For example, the system may identify a certain page based on a URL associated with a currently displayed page, via rendering information associated with a currently displayed page, via an API for the website that provides information identifying currently displayed pages, and so on.

Once the location within the website is identified, the system, in operation 420, selects and/or generates interaction information based on the identified location. For example, the influence module 322 of the influence display engine 312 performs a rules-based process in order to select interaction information to display within the identified location of the website.

As described herein, the system may follow a variety of different rules when selecting and/or generating interaction information to be displayed within a page of a website. In some examples, the rules may be represented as follows:

“When <page type> is the identified location, generate <influence X>”.

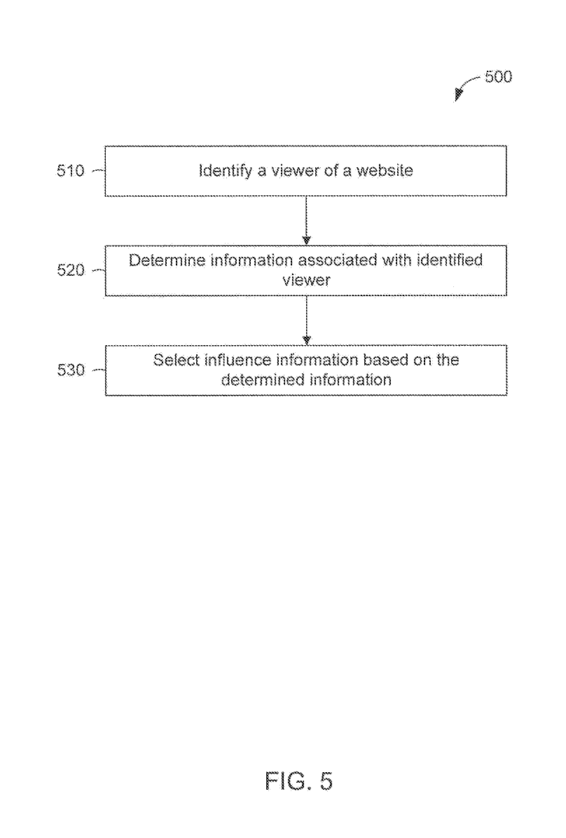

However, in some examples, the system may also utilize other information when selecting and/or generating interaction information. FIG. 5 is a flow diagram illustrating a method 500 for selecting the interaction information to display based on a viewer of a website, in some example embodiments.

In operation 510, the system identifies a viewer of a website. For example, the user identification module 324 may identify a current viewer of a page within the website based on the user being a member of the website, based on the user's IP address, based on cookies associated with the website, and so on. In operation 520, the system determines information associated with the current viewer, such as information associated with a user type for the viewer, information associated with a current online session for the viewer, information associated with a previous online history for the viewer, information associated with a previous purchase history for the viewer, and so on.

In operation 530, the system selects interaction information based on the information associated with the viewer of the website. For example, the system may follow another rules-based process that includes information associated with the viewer of the website, such as:

“When viewer is <user type> and associated with <history type>, generate interaction information that includes <influence Y>.”

Returning to FIG. 4, in operation 430, the system presents the interaction information at or proximate to the identified location within the website. For example, the publication engine 302 of the publication system 202 displays and/or presents the selected interaction information via the website at a predetermined location within a page of the website, such as at a location proximate to product description information (e.g., a picture of a product), proximate to graphical elements of a shopping cart page (e.g., a displayed purchase button), proximate to purchase review information (e.g., a displayed checkout button), and so on.

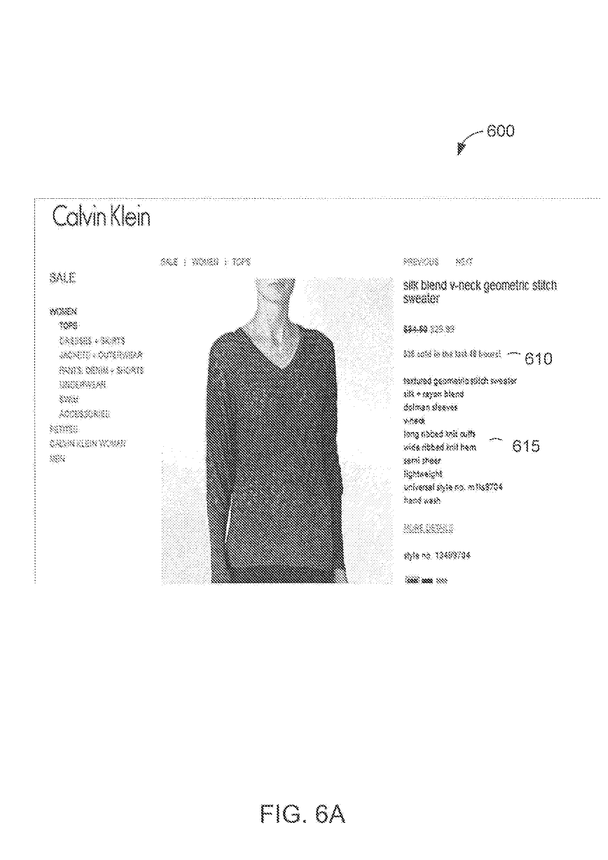

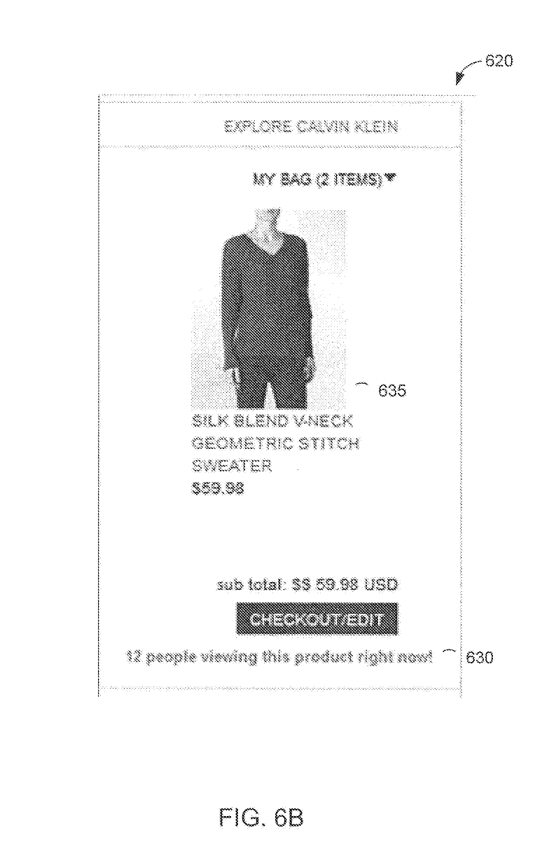

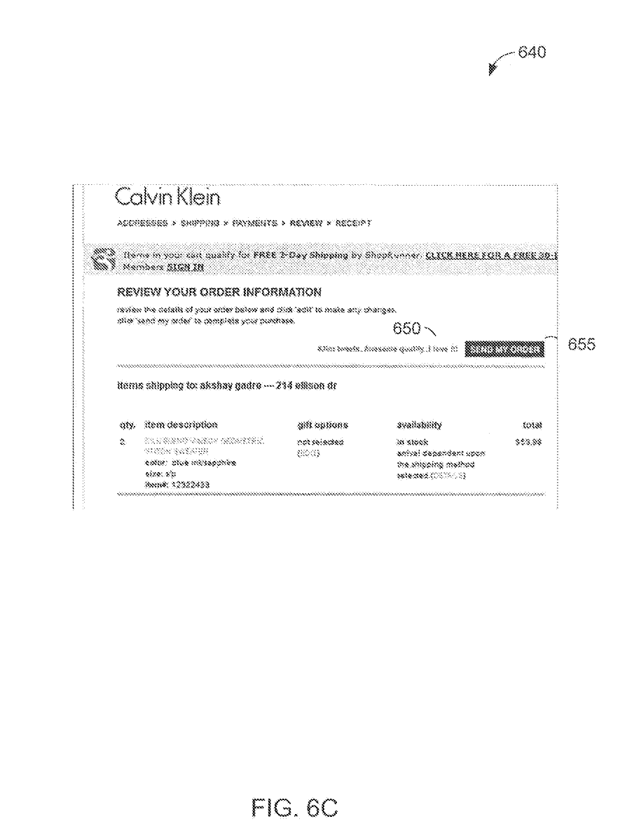

Thus, in some examples, the influence display system described herein enables a publication system 202 to strategically present interaction information at various locations or pages within a website. FIGS. 6A-6C are display diagrams illustrating displayed interaction information within various pages presented by a website, in some example embodiments.

For example, FIG. 6A depicts interaction information 610 displayed within a product page 600, such as a product description page, of a website. The system selects the interaction information 610 to be displayed based on some or all of the techniques described herein, and displays the selected interaction information 610 proximate to product description information 615 displayed within the product page 600.

in another example, FIG. 6B depicts interaction information 630 displayed within a product purchase page 620, such as a shopping cart page, of a website. The system selects the interaction information 630 to be displayed based on some or all of the techniques described herein, and displays the selected interaction information 630 proximate to product description information 635 displayed within the purchase page 620.

In another example, FIG. 6C depicts interaction information 650 displayed within a review page 640, such as a purchase review page, of a website. The system selects the interaction information 650 to be displayed based on some or all of the techniques described herein, and displays the selected interaction information 650 proximate to purchase finalization buttons 655 displayed within the review page 640.

Of course, one of ordinary skill will appreciate that information may be displayed within a variety of different locations of a website, such as an auction website, an online retailer, and so on, such as a main listings section, a sidebar displaying recommended or preferred products, among other things.

Thus, in some examples, the influence display system described herein enables a website to introduce influential information at various locations within a website, enabling the website to provide users with targeted, interaction-based information associated with products and services they are viewing and/or purchasing, among other benefits.

### Conclusion

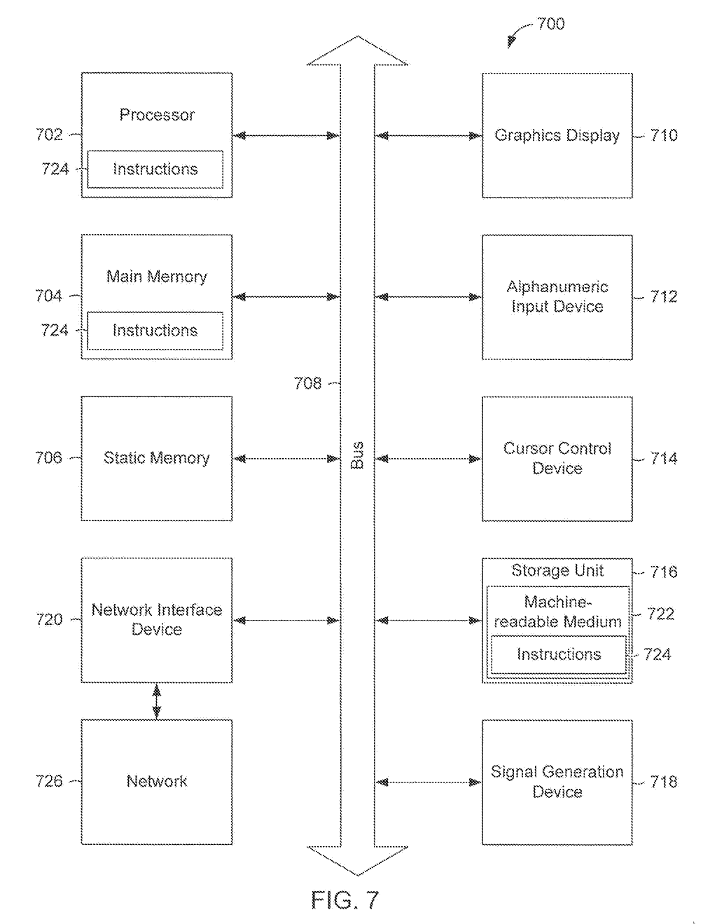

FIG. 7 shows a diagrammatic representation of machine in the exemplary form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (Pc), a tablet PC, a set-top box (STB), a Personal Digital Assistant (PDA), cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU) a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies described herein, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as afield programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

Although the present disclosure has been described with reference to specific exemplary embodiments, it may be evident that various modifications and changes may be made to these embodiments without departing from the broader spirit and scope of the disclosure. Accordingly, the specification and drawings are to be regarded in an illustrative rather than a restrictive sense.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The preceding technical disclosure is intended to be illustrative, and not Restrictive. For example, the above-described embodiments (or one or more aspects thereof) may be used in combination with each other. Other embodiments will be apparent to those of skill in the art upon reviewing the above description.

In this document, the terms “a” or “an” are used, as is common in patent documents, to include one or more than one. In this document, the term “or” is used to refer to a nonexclusive or, such that “A or B” includes “A but not B,”“B but not A,” and “A and B,” unless otherwise indicated. Furthermore, all publications, patents, and patent documents referred to in this document are incorporated by reference herein in their entirety, as though individually incorporated by reference. 1.11 the event of inconsistent usages between this document and those documents so incorporated by reference, the usage in the incorporated reference(s) should be considered supplementary to that of this document; for irreconcilable inconsistencies, the usage in this document controls.

What is claimed:

1. A system, comprising:
a location identification module configured to identify a location within a user interface in which to display interaction information for a product presented by the user interface, the interaction information reflecting a degree of interaction relating to the product; and
an interaction module configured to select interaction information to display at the identified location within the website based on a rules-based process that uses the identified location within the user interface.

2. The system of claim 1, further comprising:
a publication module configured to publish the selected interaction information at or proximate to the identified location within the user interface.

3. The system of claim 1, wherein the location identification module is configured to identify a location within a user interface that displays products to be purchased via the website by viewers of the website.

4. The system of claim 1, wherein the location identification module is configured to identify a location within a flow of pages that facilitate a purchase of a product via the website.

5. The system of claim 1, wherein the influence module is configured to select interaction information derived from activities associated with interactions within a social network between the product and members of the social network.

6. The system of claim 1, wherein the influence module is configured to generate an influence element based on interaction information received from a social network that is associated with the member interactions with the product within the social network.

7. The system of claim 1, wherein the influence module is configured to select first interaction information when the identified location within the user interface is a product description page, second interaction information when the identified location within the user interface is a product purchase page, and third interaction information when the identified location within the user interface is a product review page.

8. A computerized method, comprising:
receiving an indication that a viewer has navigated to a user interface associated with a product available for purchase via a network-based system;
selecting an influence element associated with the user interface navigated to by the viewer; and
displaying the influence element via the user interface.

9. The method of claim 8, wherein the user interface is a web page, and the network-based system is accessible via a website.

10. The method of claim 8, wherein the selected influence element includes interaction information associated with the product that is derived from a social network.

11. The method of claim 8, wherein the selected influence element includes interaction information identifying a number of likes of the product by members of a social network.

12. The method of claim 8, wherein the selected influence element includes interaction information identifying a number of current viewers of information relating to the product.

13. The method of claim 8, wherein the selected influence element includes interaction information associated with the product that is dynamically generated during or after the viewer navigates to the page associated with the product.

14. The method of claim 8, wherein the page associated with the product available for purchase via the website includes a product page that displays a product description for the product.

15. The method of claim 8, wherein the page associated with the product available for purchase via the website includes a purchase page that facilitates a purchase of the product by the viewer of the page.

16. The method of claim 8, wherein the page associated with the product available for purchase via the website includes a product review page that displays one or more reviews for the product.

17. A computer-readable storage medium whose contents, when executed by a computing system, cause the computing system to perform operations comprising:
displaying a graphical element via a web page of the website, the graphical element including interaction information that is associated with a product for purchase via the website and that is selected to be displayed via the web page based on the web page.

18. The computer-readable medium of claim 17, wherein the interaction information is selected based on the web page being a product description page.

19. The computer-readable medium of claim 17, wherein the interaction information is selected based on the web page including product description information.

20. The computer-readable medium of claim 17, wherein the interaction information is selected based on the web page being a product purchase page.
